(19) United States
(12) Patent Application Publication
(10) Pub. No.: US 2015/0248799 A1
(43) Pub. Date: Sep. 3, 2015

(54) FINGERPRINT IDENTIFICATION SYSTEM FOR VEHICLE AND VEHICLE SMART KEY INCLUDING THE SAME

(71) Applicant: LG INNOTEK CO., LTD., Seoul (KR)

(72) Inventors: Dong Keon LEE, Seoul (KR); Dong Mug SEONG, Seoul (KR); Chung Wan LEE, Seoul (KR); Jae Hak HER, Seoul (KR)

(21) Appl. No.: 14/624,230

(22) Filed: Feb. 17, 2015

(30) Foreign Application Priority Data
Feb. 28, 2014 (KR) 10-2014-0024274
May 19, 2014 (KR) 10-2014-0059697

(51) Int. Cl. G07C 9/00

(52) U.S. Cl. CPC G07C 9/00158

(57) ABSTRACT

A fingerprint identification system including a starting button unit including a starting touch panel to extract a fingerprint of a user, a door handle including a door touch panel to extract the fingerprint of the user; and a control unit to control starting of a vehicle by comparing the extracted fingerprint of the user with a fingerprint, which is previously stored, and to generate an alarm signal. The starting touch panel is provided on a starting button unit.

### BACKGROUND

The embodiment relates to a vehicle control system and a vehicle smart key including the same.

In general, a vehicle is configured to allow a user to unlock a locking device, which is mounted at a door handle of a vehicle door, with a vehicle key, to open the vehicle door for getting on the vehicle, and then to operate an ignition key mounted at a steering shaft with the vehicle key to start an engine so that the vehicle can be driven. In contrast, when the driving of the vehicle is stopped, the user turns off the ignition switch with the vehicle key to stop the operation of the start. In addition, when getting off the vehicle, the user locks the locking device mounted at the door handle with the vehicle key for vehicle security.

In addition, a device, which controls the locking/unlocking of a vehicle door locking device and the starting of an engine at a remote place, is developed and used in a vehicle employing a remote starting device, so that a driver can conveniently drive the vehicle after warming up the vehicle through the remote starting of the vehicle, especially in the winter.

However, recently, as vehicle robbery cases frequently occur, various anti-robbery devices have been developed and used. For example, a certain anti-robbery device is configured to actuate a vehicle security device when a human body approaches or makes contact with a parking or stopping vehicle, and another anti-robbery device is configured to actuate a vehicle security device when a vehicle door is tried to be open or an engine is tried to be started through an abnormal tool.

As described above, according to the vehicle of the related art, the locking/unlocking of a door lock device or the starting of the engine may be performed using a vehicle key, or a remote starting scheme has been developed. However, according to the above schemes, a stranger can easily open/close the vehicle door and start the engine of the vehicle. Even if a vehicle security device is actuated, the vehicle owner cannot recognize the actuation state of the vehicle security device so that the vehicle owner cannot appropriately cope with the vehicle robbery, when a vehicle owner is slightly away from the vehicle.

### SUMMARY

The embodiment provides a vehicle control system capable of enhancing security and improving reliability and a smart key capable of easily controlling the operation of a vehicle.

According to the embodiment, there is provided a fingerprint identification system including a starting button unit comprising a starting touch panel to extract a fingerprint of a user, a door handle comprising a door touch panel to extract the fingerprint of the user, and a control unit to control starting of a vehicle by comparing the extracted fingerprint of the user with a fingerprint, which is previously stored, and to generate an alarm signal. The starting touch panel is provided on a starting button unit.

In addition, according to the embodiment, there is provided a vehicle smart key including a touch input unit to receive a user input pattern, a storage unit to store at least one user input pattern input through the touch input unit and an operation control signal of a vehicle corresponding to the user input pattern, a control unit to detect the at least one user input pattern input through the touch input unit and to extract the vehicle operation control signal corresponding to the input user input pattern, and a communication unit to transmit the vehicle operation control signal corresponding to the user input pattern, which is extracted by the control unit, to the vehicle.

The fingerprint identification system according to the embodiment can improve the reliability of fingerprint identification by identifying the fingerprint using the touch panel.

The fingerprint identification system according to the present invention can enhance the security of the vehicle by checking the fingerprint of the user several times by mutually different components.

In addition, according to the vehicle smart key of the embodiment, the operation of the vehicle can be easily controlled through various and complex user inputs such as the touch input or the motion input of the user.

Further, the operation of the vehicle can be controlled with more enhanced security based on various patterns and various motions personally set by the user.

### BRIEF DESCRIPTION OF THE DRAWINGS

FIG. 1 is a block diagram showing a vehicle control system according to a first embodiment.

FIGS. 2 and 3 are views showing a smart key according to the first embodiment.

FIG. 4 is a view showing a door handle unit according to the first embodiment.

FIG. 5 is a view showing a starting button unit according to the first embodiment.

FIG. 6 is a flowchart showing a processing procedure of the fingerprint identification system according to the first embodiment.

FIG. 7 is a flowchart showing a processing procedure of the fingerprint identification system according to another example of the first embodiment.

FIG. 8 is a block diagram showing the structure of a vehicle control system according to a second embodiment.

FIG. 9 is a view showing a smart key according to the second embodiment.

FIG. 10 is a block diagram showing the internal structure of the smart key according to the second embodiment.

FIG. 11 is a flowchart showing an operation of setting a user pattern according to the second embodiment.

FIG. 12 is a flowchart showing an operation of controlling a vehicle using the smart key according to second embodiment.

### DETAILED DESCRIPTION OF THE EMBODIMENTS

Hereinafter, the embodiment will of the disclosure will be described in detail with reference to accompanying drawings.

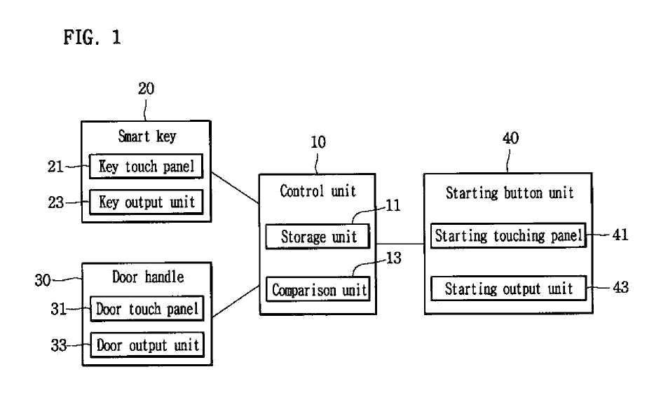

Hereinafter, a vehicle control system according to a first embodiment will be described with reference to FIGS. 1 to 7.

Referring to FIGS. 1 to 5, the vehicle control system according to the first embodiment may include a control unit 10, a smart key 20, a door handle 30, and a starting button unit 40.

The control unit 10 may include a storage unit 11 and a comparison unit 13.

The control unit 10 compares input fingerprint information with fingerprint information of a user, which is previously stored, and controls the opening/closing of a door and the starting of a vehicle to output a relevant signal.

The storage unit 11 may store the fingerprint information of the user. The storage unit 11 may store fingerprint information of a plurality of users. In the case of a plurality of drivers, the storage unit 11 may store fingerprint information of a plurality of users.

The comparison unit 13 may compare the fingerprint information of the user stored in the storage unit 11 with the input fingerprint information. When fingerprint information of a plurality of users is stored in the storage unit 11, the comparison unit 13 may sequentially compare the input fingerprint information with the finger information of the users stored in the storage unit 11.

The smart key 20 may include a key touch panel 21 and a key output unit 23.

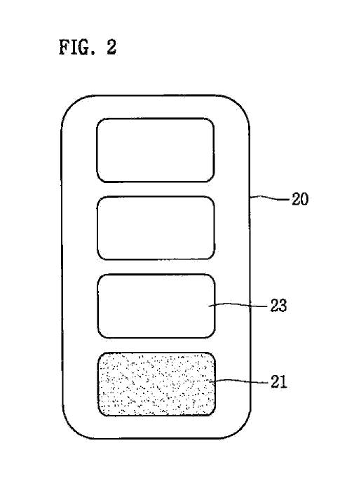

The key touch panel 21 may detect the fingerprint of a user. Referring to FIGS. 2 and 3, the key touch panel 21 may be an area type of a key touch panel or a swipe type of a key touch panel.

FIG. 2 is a view showing the area type of a key touch panel 21.

The key touch panel 21 makes surface contact with a finger of a user to detect the fingerprint of the user. The key touch panel 21 may detect the variation of capacitance on a surface making contact with the fingerprint of the user to detect the fingerprint of the user.

In general, a fingerprint has a peak and a valley through a ridge. The size of the ridge is about 0.5 mm, and the width of the valley between ridges of a fingerprint is in the range of 0.05 mm to 0.2 mm.

The area type of the key touch panel 21 makes contact with the peak of the fingerprint and is spaced apart from the valley of the fingerprint. The key touch panel 21 detects the variation of capacitance generated depending on the distances of the peak and the valley from the key touch panel 21. Accordingly, the ridge of the fingerprint can be acquired. The key touch panel 21 may acquire the ridge of the fingerprint to detect the fingerprint of the user.

The key touch panel 21 recognizes through a touch panel instead of an additional touch sensor, so that the reliability of the fingerprint identification can be improved.

FIG. 3 is a view showing a swipe type of the key touch panel 21.

The swipe type of the key touch panel 21 may detect the fingerprint of a user when the finger of the user passes the key touch panel 21.

In other words, while the finger of the user passes the key touch panel 21, the key touch panel 21 divides the fingerprint of the user to recognize the fingerprint of the user, so that the whole fingerprint of the user can be detected. The swipe type of the key touch panel 21 may have a size smaller than that of the area type of the key touch panel 21. The swipe type of the key touch panel 21 may have a size corresponding to ⅓ of the size of the area type of the key touch panel 21.

When the key touch panel 21 is configured in a swipe type, the key touch panel 21 may have a smaller size as compared with when the key touch panel 21 is configured in an area type, so that the size of the smart key 20 can be reduced.

The key output unit 23 may output a voice or an image by an instruction from the control unit 10. The key output unit 23 may include a speaker or a display. When the key output unit 23 includes the speaker, the key output unit 23 may output a voice by the instruction from the control unit 10. When the key output unit 23 includes the display, the key output unit 23 may output an image by the instruction from the control unit 10.

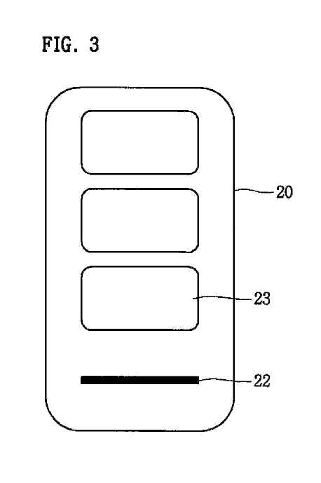

Referring to FIG. 4, the door handle 30 may include a door touch panel 31 and a door output unit 33. The door touch panel 31 may detect the fingerprint of the user. The door touch panel 31 may include an area type or a swipe type of a touch panel. The door touch panel 31 may detect the fingerprint of the user through the same procedure as that of the key touch panel 21.

The door touch panel 31 may be positioned on a door handle. When the door touch panel 31 is positioned on the door handle, and when a user opens a door, the user can input the fingerprint of the user without another motion, so that the door touch panel 31 can conveniently recognize the user.

The door output unit 33 may output a voice or an image by an instruction. The door output unit 33 may include a speaker and a display. When the door output unit 33 includes the speaker, the door output unit 33 may output a voice by the instruction from the control unit 10. When the door output unit 33 includes the display, the door output unit 33 may output an image by the instruction from the control unit 10.

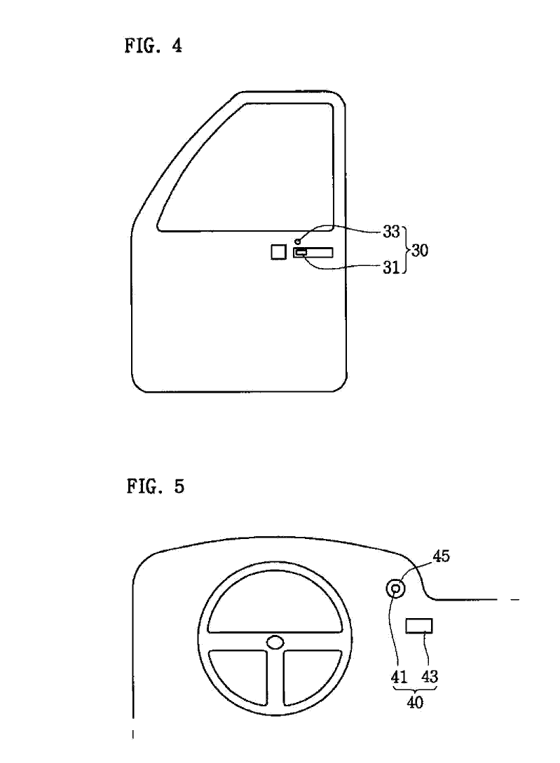

Referring to FIG. 5, the starting button unit 40 may include a starting touch panel 41 and a starting output unit 43.

The starting touch panel 41 may detect the fingerprint of the user. The starting touch panel 41 may include an area type or a swipe type of a touch panel. The starting touch panel 41 may detect the fingerprint of the user through the same procedure as that of the key touch panel 21.

The starting touch panel 41 may be formed on the starting button 45. Since the starting touch panel 41 is formed on the starting button 45, an addition space for the starting touch panel 41 may be omitted.

Since the starting touch panel 41 may be formed on the starting button 45, when an engine is started, the fingerprint of the user can be detected, and the user can be identified, thereby preventing vehicle robbery.

The starting output unit 43 may output a voice or an image by an instruction from the control unit 10. The starting output unit 43 may include a speaker and a display. When the starting output unit 43 includes the speaker, the starting output unit 43 may output a voice by the instruction from the control unit 10. When the starting output unit 43 includes the display, the starting output unit 43 may output an image by the instruction from the control unit 10.

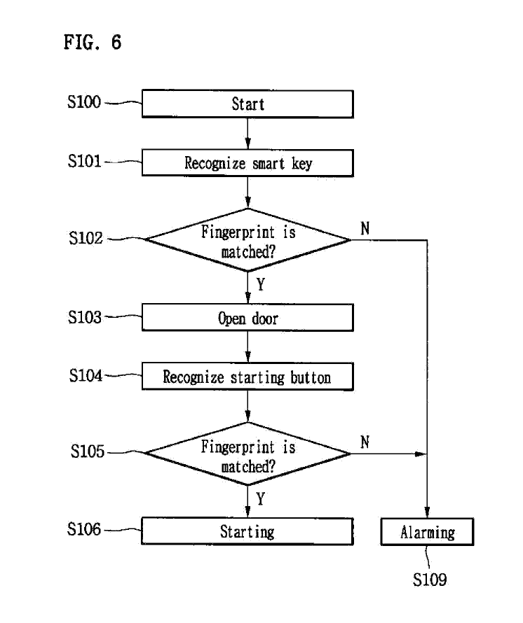

FIG. 6 is a flowchart showing a processing procedure of the vehicle control system according to the first embodiment.

Referring to FIG. 6, in the processing procedure of the vehicle control system according to the first embodiment, fingerprint recognition is waited in a starting step (S100).

If the finger of a user makes contact with the key touch panel 21 of the smart key 20, the key touch panel 21 extracts the fingerprint of the user (S101).

The comparison unit 13 of the control unit 10 compares the extracted fingerprint of the user with a fingerprint which is previously stored in the storage unit 11 and determines the matching status between the two fingerprints to identify a user.

If multiple pieces of fingerprint information are stored in the storage unit 11, the comparison unit 13 sequentially compares the input fingerprint information with the multiple pieces of fingerprint information stored in the storage unit 11 to identify the user.

If the stored fingerprint information is not matched with the input fingerprint information, the control unit 10 transmits an alarm signal (S109).

The control unit 10 may transmit the alarm signal to the smart key 20. If the alarm signal is transmitted to the smart key 20, the smart key 20 outputs alarm information through the key output unit 23.

When the key output unit 23 includes a speaker, the key output unit 23 may output an alarm sound or a voice signal. When the key output unit 23 includes a display, the key output unit 23 may output an alarm screen.

If the stored fingerprint information is matched with the input fingerprint information, the control unit 10 transmits a door open signal to the door handle 30. The door of the vehicle is opened by the door open signal (S103).

After the door of the vehicle has been open, the user gets on the vehicle and brings the finger of the user in contact with a starting button 45. Since the starting touch panel 41 is positioned on the starting button 45, the starting touch panel 41 detects the fingerprint of the user (S104).

The comparison unit 13 of the control unit 10 compares the fingerprint of the user extracted by the starting touch panel 41 with the fingerprint that is previously stored in the storage unit 11 and determines the matching status between the two fingerprints to identify the user (S105).

If multiple pieces of fingerprint information are stored in the storage unit 11, the comparison unit 13 sequentially compares the input fingerprint information with the multiple pieces of fingerprint information stored in the storage unit 11 to identify the user.

If the stored fingerprint information is not matched with the input fingerprint information, the control unit 10 transmits an alarm signal (S109).

The control unit 10 may transmit the alarm signal to the smart key 20. If the alarm signal is transmitted to the smart key 20, the smart key 20 outputs alarm information through the key output unit 23.

When the key output unit 23 includes a speaker, the key output unit 23 may output an alarm sound or a voice signal. When the key output unit 23 includes a display, the key output unit 23 may output an alarm screen.

The control unit 10 may transmit the alarm signal to a speaker embedded in the vehicle. If the alarm signal is transmitted to the speaker embedded in the vehicle, the speaker may output an alarm sound or alarm voice to notify the user of the vehicle robbery.

If the stored fingerprint information is matched with the input fingerprint information, the control unit 10 starts the engine of the vehicle (S106).

Description has been made regarding the opening of the door of the vehicle with reference to FIG. 6 for the illustrative purpose. Accordingly, the fingerprint matching status of the user is determined twice by the smart key 20 and the starting button 40, thereby enhancing the security of the vehicle.

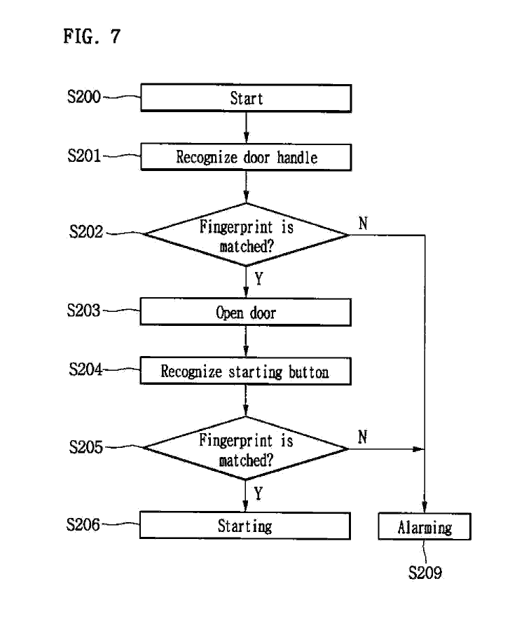

FIG. 7 is a flowchart showing a processing procedure of the vehicle control system according to another example of the first embodiment.

Referring to FIG. 7, in the processing procedure of the vehicle control system according to another example of the first embodiment, fingerprint recognition is waited in a starting step (S200).

If the finger of the user makes contact with the door touch panel 31, the door touch panel 31 extracts the fingerprint of the user (S201).

The comparison unit 13 of the control unit 10 compares the extracted fingerprint of the user with a fingerprint which is previously stored in the storage unit 11 and determines the matching status between the two fingerprints to identify a user (S202).

If multiple pieces of fingerprint information are stored in the storage unit 11, the comparison unit 13 sequentially compares the input fingerprint information with the multiple pieces of fingerprint information stored in the storage unit 11 to identify the user.

If the stored fingerprint information is not matched with the input fingerprint information, the control unit 10 transmits an alarm signal (S209).

The control unit 10 may transmit the alarm signal to the door handle 30. If the alarm signal is transmitted to the door handle 30, the door handle 30 outputs alarm information through the door output unit 33.

When the door output unit 33 includes a speaker, the door output unit 33 may output an alarm sound or a voice signal. When the door output unit 33 includes a display, the door output unit 33 may output an alarm screen.

The control unit 10 may transmit the alarm signal to the smart key 20. If the alarm signal is transmitted to the smart key 20, the smart key 20 outputs alarm information through the key output unit 23.

When the key output unit 23 includes a speaker, the key output unit 23 may output an alarm sound or a voice signal. When the key output unit 23 includes a display, the key output unit 23 may output an alarm screen.

If the stored fingerprint information is matched with the input fingerprint information, the control unit 10 transmits a door open signal to the door handling unit 30. The door of the vehicle is opened by the door open signal (S203).

After the door of the vehicle has been open, the user gets on the vehicle and brings the finger of the user in contact with the starting button 45. Since the starting touch panel 41 is positioned on the starting button 45, the starting touch panel 41 detects the fingerprint of the user (S204).

The comparison unit 13 of the control unit 10 compares the fingerprint of the user extracted by the starting touch panel 41 with the fingerprint that is previously stored in the storage unit 11 and determines the matching status between the two fingerprints to identify the user (S205).

If multiple pieces of fingerprint information are stored in the storage unit 11, the comparison unit 13 sequentially compares the input fingerprint information with the multiple pieces of fingerprint information stored in the storage unit 11 to identify the user.

If the stored fingerprint information is not matched with the input fingerprint information, the control unit 10 transmits an alarm signal (S209).

The control unit 10 may transmit the alarm signal to the smart key 20. If the alarm signal is transmitted to the smart key 20, the smart key 20 outputs alarm information through the key output unit 23.

When the key output unit 23 includes a speaker, the key output unit 23 may output an alarm sound or a voice signal. When the key output unit 23 includes a display, the key output unit 23 may output an alarm screen to notify the user of the vehicle robbery.

The control unit 10 may transmit the alarm signal to the speaker embedded in the vehicle. If the alarm signal is transmitted to the speaker embedded in the vehicle, the speaker may output an alarm sound or alarm voice to notify the user of the vehicle robbery.

If the stored fingerprint information is matched with the input fingerprint information, the control unit 10 starts the engine of the vehicle (S206).

According to another example, description has been made regarding the opening of the door of the vehicle having the door handle 30 for the illustrative purpose. Accordingly, the fingerprint matching status of the user is determined twice by the door handle 30 and the starting button 40, thereby enhancing the security of the vehicle.

As described above, the fingerprint identification system selectively operates through mutually different processing procedures shown in FIGS. 6 and 7. For example, when the user opens the door of the vehicle with the smart key 20, the user is identified through the processing procedure shown in FIG. 6. When the user opens the door of the vehicle with the door handle 30, the user is identified through the processing procedure shown in FIG. 7.

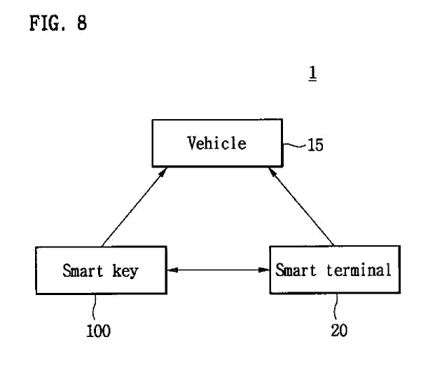

Hereinafter, a vehicle control system according to a second embodiment will be described with respect to FIGS. 8 to 12.

FIG. 8 is a block diagram showing the structure of the vehicle control system according to the second embodiment.

The vehicle control system according to the second embodiment may be operated by a smart key 100 of a user at a remote place in which the operation of a vehicle 15 is controlled. The smart key 100 according to the embodiment may control the operation of the vehicle as a touch input pattern or a motion pattern input from the user is registered in the smart key 100. In addition, when the smart key 100 is synchronized with a user terminal (for example, a smart phone, or a wearable terminal) 20 with respect to a user input pattern set in the smart key 100, the user terminal 20 can control the same vehicle as that of the smart key 100.

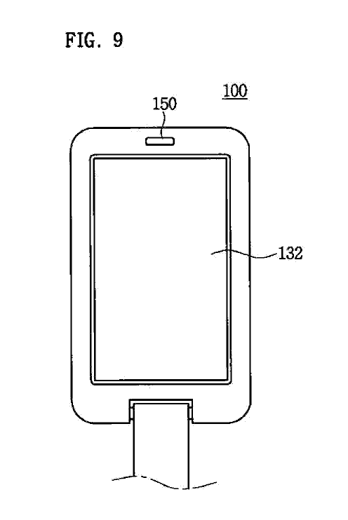

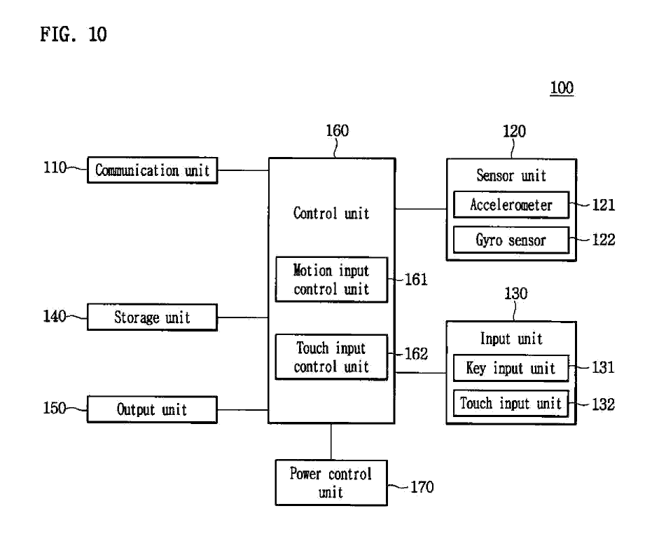

FIG. 9 is a view showing an example of a smart key 100 employing a vehicle control system according to a second embodiment. FIG. 10 is a block diagram showing the internal structure of the smart key 100 employing the vehicle control system according to the second embodiment.

Referring to FIGS. 9 and 10, the smart key 100 according to the present embodiment may includes a communication unit 110, a sensor unit 120, a storage unit 140, an output unit 150, a control unit 160, and a power supply unit 170.

The communication unit 110 may include at least one communication module to make communication with a vehicle 10 and a user terminal 20

For example, the communication unit may include a short range communication module. The short range communication module is defined as a module for the communication between devices existing within a predetermined distance (range). Short range communication technologies may include Bluetooth, radio frequency identification (RFID), infrared data association (IrDA), ultra wideband (UWB) or Zigbee.

The communication unit 110 may transmit a vehicle control signal generated due to the user input pattern set in the smart key 100 to a relevant vehicle.

The sensor unit 120 may include a sensor module to sense a motion input among user inputs set in the smart key 100.

For example, the sensor unit 120 may include an accelerometer 121 and a gyro sensor 122.

The accelerometer 121 may measure acceleration (gravity acceleration+movement acceleration) in each of X, Y, and Z axes.

The gyro sensor 122 measures an angle changed as an angular velocity is measured in X, Y, and Z axes.

Therefore, with respect to a preset user motion input to the smart key 100, the accelerometer detects a velocity and a position and the gyro sensor 122 detects a direction, so that a vehicle control signal can be generated corresponding to the relevant motion.

An input unit 130 may receive a signal for the operation control of a vehicle from a user. The input unit 130 may include a key input unit 131 and a touch input unit 132, which include a key pad, a dome switch, a touch pad, a jog wheel, or a jog switch.

In particular, the touch input unit 132 according to the second embodiment may include a touch sensor. The touch sensor may have the form of a touch film, a touch sheet, and a touch pad. The touch input unit 132 may be configured to convert pressure applied to a specific part or the change of the capacitance occurring at a specific position into an electrical input signal.

The touch input unit 132 may receive at least one input through a body of the user (for example, a finger of the user) or an input unit to provide a touch function. In particular, the touch input unit 132 may receive a user pattern to generate various control signals to control the operation of the vehicle. In other words, the touch input unit 132 may receive continuous motion for the operation control of the vehicle, that is, the moving pattern of the touch position from the user.

The storage unit 140 may store a program for the operation of the control unit 160, and may store input/output data. The storage unit 140 may store various patterns output when a touch is input to the touch input unit 132 and data related to vibration and sound effects corresponding to the various patterns. In other words, the storage unit 140 may store a vehicle operation control signal corresponding to a user input pattern input through the touch input unit 132 or a user motion pattern detected through the sensing of the sensing unit 120.

The vehicle operation control signal stored in the storage unit 140 may be stored corresponding to each user input pattern input through the touch input unit 132. In addition, the vehicle operation control signal may be stored in the storage unit 140 corresponding to the user motion pattern input into the sensor unit 120. In addition, the vehicle operation control signal may be stored in the storage unit 140 corresponding to a combination signal of the user input pattern and the user motion pattern input to the touch input unit 132 and the sensor unit 120.

The storage unit 140 may include at least one storage module of a flash memory type memory, a hard disk type memory, a multimedia card micro type memory, a card type memory (for example, SD or XD memory), a random access memory (RAM), a static random access memory (SRAM), a read-only memory (ROM), an electrically erasable programmable read-only memory (EEPROM), and a programmable read-only memory (PROM).

The output unit 150 generates visual, auditory, or tactile outputs. The output unit 150 may include an LED indication lamp. The LED indication lamp may express a reaction to the operation of the smart key 100, such as the user input or the transmission of the control signal. In addition, the output unit 150 may output various response signals, such as an audio signal and a vibration signal, corresponding to the user input and the operation of the smart key. The output unit 150 according to the embodiment of the disclosure may include a display unit to display information of the operating state of the smart key 100 and the state of the user input. The display unit may include a touch screen integrated with the touch input unit 132. Accordingly, if a user touch input is detected, the display unit may display a moving path of the touch input corresponding to the user input.

The control unit 160 generally controls the whole operation of the smart key. According to the embodiment of the disclosure, the control unit 160 detects the user input pattern and the user motion pattern input through the sensor unit 120 and the input unit 130 of the smart key 100 and generates a vehicle operation control unit corresponding to the user input pattern or the user motion pattern.

The control unit 160 may include a motion input control unit 161 and a touch input control unit 162. The motion input control unit 161 may detect a user input motion input through the sensor unit 120 and generate the vehicle operation control unit corresponding to the user input motion. The touch input control unit 162 may determine at least one preset user input pattern input through the touch input unit 132 and generate at least one vehicle operation control signal based on the determined user input pattern.

Although the description has been made regarding that the motion input control unit 161 is provided separately from the touch input control unit 162 in the control unit 160 for the illustrative purpose, the embodiment is not limited thereto. In other words, the motion input control unit 161 and the touch input control unit 162 may be configured in the form of one united control unit.

Therefore, although the combination of the user motion pattern and the user input pattern is detected, at least one vehicle operation control signal can be generated according to settings.

The control unit 160 may detect at least one of the user input pattern and the user motion pattern or the combination of the user input pattern and the user motion pattern to read out a vehicle operation control signal that is previously stored in the storage unit 140. The control unit 160 may output the read-out vehicle operation control signal to a relevant vehicle (user registration vehicle) through the communication unit 110.

The power supply unit 170 may supply power by one battery or a plurality of batteries provided in a housing of the smart key 100. The power supply unit 170 may supply power, which is input from an external power supply unit through a cable connected with a connector (not shown), to an inner part of the smart key 100. In addition, the power supply unit 170 may supply power to the inner part of the smart key 100 through various charging schemes.

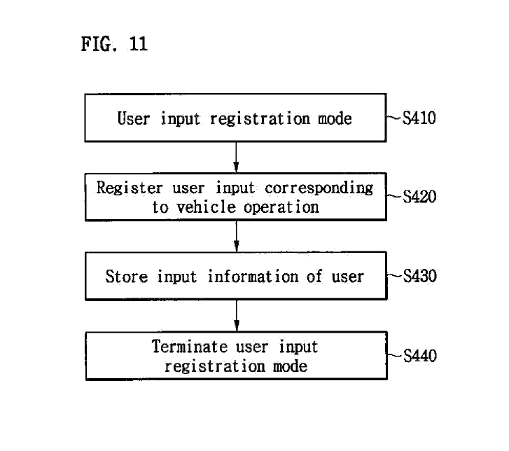

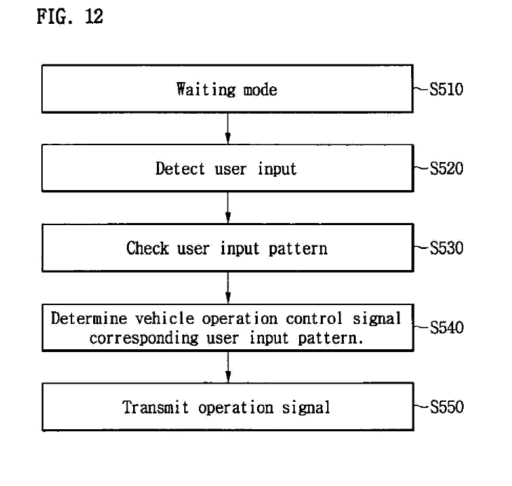

Hereinafter, a method of controlling a vehicle operation based on the user input pattern and the user motion pattern will be described in detail with reference to FIGS. 11 and 12.

FIG. 11 is a flowchart showing an operation of setting a user pattern according to the embodiment of the disclosure.

Referring to FIG. 11, the smart key 100 according to the embodiment of the disclosure may execute a user input registration mode by a user request (S410). In detail, the control unit 160 may detect a signal to request the user input registration mode through the input unit 130. The user input registration mode may be executed by activating a relevant menu by the user request.

The user input from the touch input unit 132 and the sensor unit 120 and the vehicle operation control signal corresponding to the user input may be registered in the control unit 160. In detail, at least one user input pattern from the touch input unit 132 and the vehicle operation control signal corresponding to the user input pattern may be set in the control unit 160. For example, a first user input pattern from the touch input unit 132 may be registered and set to the door locking of the vehicle. In addition, a second user input pattern may be registered and set to the starting of the vehicle. Further, a third user input pattern may be set so that the door locking, the door unlocking, and the starting of the vehicle can be simultaneously or sequentially performed.

At least one user input motion sensed by the sensor unit 120 and the vehicle operation control signal corresponding to the user input motion may be set in the control unit 160. For example, a first user input motion through the sensor unit 120 may be registered and set to the door locking of the vehicle. In addition, a second user input motion may be registered and set to the starting of the vehicle. In addition, a third user input motion may be set so that the door locking, the door unlocking, and the starting of the vehicle can be simultaneously (sequentially) performed.

In addition, the combination of the user input motion and the user input pattern from the sensor unit 120 and the touch input unit 132 and a vehicle operation control signal corresponding to the combination may be set in the controller 160 may be set in the control unit 160. For example, when a first user input motion is input from the sensor unit 120, and a first user input pattern is input from the touch input unit 132, the two user inputs may be combined and at least one vehicle operation control signal corresponding to the combination may be set.

The control unit 160 may share the user input pattern and the user input motion, and vehicle operation control signal information corresponding to the user input pattern and the user input motion with an external device registered by a user. In detail, the control unit 160 may share a user input signal and a vehicle operation control signal corresponding to the user input signal with an external terminal of the user (for example, a cellular phone, or a wearable appliance). The user input pattern and the user input motion, and vehicle operation control signals corresponding thereto may be shared through a program or an interface executed in the external terminal. Accordingly, if the user input pattern or the user input motion is detected by the external terminal, a control signal the same as the vehicle operation control signal corresponding to the user input pattern or the user input motion input from the smart key can be transmitted to a relevant vehicle and registered in the relevant vehicle.

The control unit 160 may set various user input signals and vehicle operation control signals corresponding to the various user input signals as described above. The control unit 160 stores the set information of the user inputs and the vehicle operation control signals corresponding thereto (S430) and terminates the user pattern registration mode (S440).

FIG. 12 is a flowchart showing an operation of controlling a vehicle using a smart key according to one embodiment of the disclosure.

Referring to FIG. 12, if a user input is detected during a user input standby mode operation (S520), the smart key 100 may check the user input (S530). Although the embodiment of the disclosure has been described regarding the detection of the user input during the standby mode operation for illustrative purpose, the user input may be detected when a specific mode is executed.

If the control unit 160 detects a user input pattern input through the touch input unit 132, the user input pattern may be matched with a preset vehicle operation control signal. In detail, the control unit 160 may determine if a user input pattern or a user input motion previously registered and stored in the storage unit 140 is matched with the user input. The control unit 160 may determine at least one user input pattern or user input motion and determine the vehicle operation control signal corresponding to the user input pattern or the user input motion (S540).

For example, the control unit 160 may a first user input motion or a first vehicle operation control signal corresponding to the first user input pattern. If the control unit 160 sequentially detects first and second user input patterns within a predetermined time range, the control unit 160 may extract both of first and second vehicle operation control signals corresponding to the first and second user input patterns, respectively, and sequentially transmit relevant signals to a vehicle. In addition, if the first and second input motions are sequentially detected within a predetermined time range, first and second vehicle operation control signals corresponding to the first and second user input motions, respectively, may be extracted and relevant signals may be sequentially transmitted to the vehicle.

In addition, a plurality of vehicle operation control signals may be extracted according to a user input pattern or motion input by a user. In detail, even if a plurality of user inputs are not detected, a plurality of vehicle operation control signals may be extracted and transmitted to the vehicle if a third user input is detected according to the settings of the user.

The control unit 160 may transmit a vehicle operation control signal corresponding to at least one user input pattern or motion, which is confirmed, to the relevant vehicle (S550).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments may be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A fingerprint identification system comprising:
a starting button unit comprising a starting touch panel to extract a fingerprint of a user;
a door handle comprising a door touch panel to extract the fingerprint of the user; and
a control unit to control starting of a vehicle by comparing the extracted fingerprint of the user with a fingerprint, which is previously stored, and to generate an alarm signal,
wherein the starting touch panel is provided on a starting button unit.

2. The fingerprint identification system of claim 1, wherein the control unit comprises:
a storage unit to store the fingerprint of the user; and
a comparison unit to compare the fingerprint of the user, which is previously stored, with an input fingerprint of the user.

3. The fingerprint identification system of claim 1, further comprising a smart key comprising a key touch panel to recognize the fingerprint of the user.

4. The fingerprint identification system of claim 3, wherein the key touch panel comprises an area type of a touch panel or a swipe type of a touch panel.

5. The fingerprint identification system of claim 3, wherein the smart key comprises a key output unit to output an alarm sound, a voice signal, or an image signal by an instruction of the control unit.

6. The fingerprint identification system of claim 2, wherein the storage unit stores fingerprints of a plurality of users, and the comparison unit sequentially compares an input fingerprint with the fingerprints of the users which are stored.

7. The fingerprint identification system of claim 1, wherein the control unit starts the vehicle if the stored fingerprint is matched with the fingerprint extracted from the door handle, and if the stored fingerprint is matched with the fingerprint extracted form the starting button unit.

8. The fingerprint identification system of claim 3, wherein the control unit starts the vehicle if the stored fingerprint is matched with the fingerprint extracted from the smart key, and if the stored fingerprint is matched with the fingerprint extracted form the starting button unit.

9. The fingerprint identification system of claim 1, wherein each of the starting button unit and the door handle comprises an output unit to output an alarm sound, a voice signal, or an image signal by an instruction of the control unit.

10. The fingerprint identification system of claim 9, wherein the output unit comprises a speaker or a display.

11. A vehicle smart key comprising:
a touch input unit to receive a user input pattern;
a storage unit to store at least one user input pattern input through the touch input unit and an operation control signal of a vehicle corresponding to the user input pattern;
a control unit to detect the at least one user input pattern input through the touch input unit and to extract the vehicle operation control signal corresponding to the input user input pattern; and
a communication unit to transmit the vehicle operation control signal corresponding to the user input pattern, which is extracted by the control unit, to the vehicle.

12. The vehicle smart key of claim 11, wherein the storage unit stores a first user input pattern and a first vehicle operation control signal by matching the first user input pattern and the first vehicle operation control signal with each other, and the control unit extracts the first vehicle operation control signal if the first user input pattern is detected.

13. The vehicle smart key of claim 11, wherein the storage unit stores a first user input pattern and first and second vehicle operation control signals by matching the first user input pattern with the first and vehicle operation control signals, and the control unit extracts the first and second vehicle operation control signals if the first user input pattern is detected.

14. The vehicle smart key of claim 11, further comprising a sensor unit to sense a user input motion, wherein the storage unit stores a vehicle operation control signal corresponding to the user input motion input through the sensor unit.

15. The vehicle smart key of claim 14, wherein the storage unit stores a first user input motion input through the sensor unit and a first vehicle operation control signal by matching the first user input pattern and the first vehicle operation control signal with each other, and the control unit extracts the first vehicle operation control signal if the first user input motion is detected.

16. The vehicle smart key of claim 14, wherein the storage unit stores a first user input motion input through the sensor unit and first and second vehicle operation control signals by matching the first user input motion with the first and vehicle operation control signals, and the control unit extracts the first and second vehicle operation control signals if the first user input motion is detected.

17. The vehicle smart key of claim 14, wherein the control unit extracts at least one vehicle operation control signal by combining user inputs input through the sensor unit and the touch input unit.

18. The vehicle smart key of claim 11, further comprising an interface to share the user input pattern input through the touch input unit and the vehicle operation control signal corresponding to the user input pattern with an external terminal device which is preset.
